(19) United States
(12) Patent Application Publication
(10) Pub. No.: US 2011/0295568 A1
(43) Pub. Date: Dec. 1, 2011

(54) Method for determining a vortex geometry

(76) Inventor: Berend van der Wall, Braunschweig (DE)

(21) Appl. No.: 12/788,733

(22) Filed: May 27, 2010

(51) Int. Cl. G06G 7/57; G06G 7/64; G06F 17/10

(52) U.S. Cl. 703/2; 703/7; 703/9

(57) ABSTRACT

The invention relates to a method for determining a vortex geometry change of rotor vortices which are formed on a rotor which comprises a plurality of rotor blades. A dynamic lift distribution on the rotor plane is determined as a function of a lift change, which is correlated with n-times the rotor rotation frequency, on the rotor blades, from which the associated induced vertical velocities on the rotor plane can then be determined. The vortex geometry change is then calculated as a function of these induced vertical velocities.

The invention relates to a method for determining a vortex geometry change of rotor vortices which are formed on a rotor which comprises a plurality of rotor blades. The invention likewise relates to a method for determining a vortex geometry relating to this. The invention also relates to a computer program relating to this.

In virtually all development fields it has now become self-evident for the technical components and appliances to be developed to be tested in advance with the aid of appropriate simulation programs, at least virtually using appropriately constructed real conditions, in order in this way to obtain knowledge at an early stage of the behavior of a newly designed component. For this purpose, the components are generally designed with the aid of a CAD program on a computer, with the behavior of the component in operation being simulated with the aid of the simulation program. The knowledge relating to this considerably simplifies and reduces the design work for the component, since design errors can be identified at an early stage in this way, which would otherwise have been identified only in a much later development phase, for example when the component is actually physical tested in real conditions. The simulation of technical components therefore has a direct technical influence on the development and design of these components.

Simulation programs are also being increasingly used for the development of rotary-wing aircraft, in particular helicopters, in order to simulate the behavior of a helicopter during flight. Simulation is extremely worthwhile in particular for the critical parts such as the fuselage and rotor, since this makes it possible to determine at least approximately at an early stage what characteristics the corresponding component has when subjected to the given constraints, and the loads to which the component is statically and dynamically subjected.

For example, one particular requirement during the development of rotors for helicopters is that they do not exceed a certain volume level when subjected to the given constraints. Particularly during the landing approach, specific limit values must not be exceeded here. For this reason, it is expedient to be able to reduce the corresponding development costs by first of all simulating the acoustics of helicopters and their rotors, in order in this way to make it possible to find out whether a rotor that has been developed is compliant with these specified volume conditions. Otherwise, a rotor such as this would have to be constructed and then tested in real conditions, which would increase the development costs and the development time. Furthermore, other parameters, such as the power and dynamics, the aerodynamics and the aerodynamic elasticity of a rotor such as this, can also be simulated at an early stage.

In particular, the vortices produced at the rotor blade tips play a major role in the acoustics of a helicopter rotor. Each rotor of a rotary-wing aircraft comprises, as is known, a plurality of rotor blades which, at a corresponding velocity of revolution or rotation frequency, with a radial and azimuth lift distribution of the rotor blades, create air vortices at the rotor blade ends (on the inside and on the outside and possibly also in between) which have a major influence on the acoustic behavior of the entire rotor. In the general form, it can be stated that the noise development becomes higher the closer a rotor blade moves past a vortex which is produced by the rotor blade tips.

The following statements are based on the assumption that a rotor blade which is facing aft has an angle of 0°, while a rotor blade facing forward has a revolution angle of 180°. The respective vertical positions of the rotor blades to the left and right of the fuselage are then respectively 90° and 270°. In particular, those vortices which are produced in a range from 90° to 270° of the rotor blade position have a corresponding influence on the acoustics of the rotor, since it is precisely these vortices which are supported by the rotor plane during forward flight. The vortices produced between 270° and 90°, that is to say aft of the rotor axis, in contrast have no influence oh the acoustics, since, assuming a forward velocity of flight, they are supported immediately behind the rotor plane and can therefore no longer be intersected by rotor blades from behind. The vortices produced in the forward area (90° to 270° in front of the rotation axis) are in contrast supported by the rotor plane during forward flight, and are thus intersected by rotor blades from behind. The rotor lift leads to an induced downwind field on the rotor plane, which supports the vortices moving through this underneath.

In this case, it can be stated that the faster the helicopter is flying, the less rotor blades from behind; can intersect the vortex, since the latter is supported at a correspondingly higher velocity by the rotor plane. In contrast, during a slow landing approach, the vortices which are produced are intersected correspondingly often by rotor blades from behind, since they migrate only very slowly aft through the rotor plane. A further exacerbating factor here, particularly during the landing approach, is that the vortices which are produced are also not strongly supported at the bottom by the air flowing through the rotor since, because of the rate of descent, the vortices have a corresponding tendency to descend more slowly.

For simulation of the acoustics of a helicopter with a rotor, it is therefore essential to be able to predict at least the position of the vortices, to be precise of the entire vortex system, when subject to the given constraints, in order in this way to make it possible to calculate the position of the rotor blades relative to the individual vortices, and therefore, from this, the acoustics. The problem in this case is that there is no analytical solution for this, since the geometry of the vortex system depends on a very large number of parameters, to be precise for example on the operating parameters such as the velocity of flight, the inclination of the rotor in space, the rotor thrust produced, the rotor rotation velocity and many more. Furthermore, the radial distribution of the lift likewise influences the position of the vortices in space.

In the end, two calculation methods are known from the prior art for calculation of the vortex geometry and therefore for simulation of the acoustics. One method is the so-called free-wake method, in which the complete equation of motion of the vortex system is solved, which involves considerable computation complexity. The other method is the so-called prescribed-wake method, in which the vortex geometry is calculated approximately, assuming constant external operating conditions, thus leading to considerable savings in the computation complexity.

In the so-called free-wake method, the complete equation of motion of the vortex system is solved by subdividing the entire system into several thousand vortex segments in discrete form, and by obtaining the geometry in space and time by numerical integration of the equation of motion in time. This requires considerable computation complexity, as will be illustrated briefly using one example in the case of a four-blade rotor, the rotor blades must be subdivided into at least 20 discrete blade segments in order to calculate the rotor acoustics, thus resulting in 21 vortices at the element boundaries in the wake for each rotor blade. There are therefore 84 vortex elements (21×4) for the entire rotor. Furthermore, at least 72 vortex segments must be considered in each revolution, and this corresponds to an arc length of 5°. This results in 6048 vortex segments to be investigated per revolution. In order to obtain the vortex induction on the rotor sufficiently accurately, the vortex system must be obtained for approximately five complete revolutions behind, each rotor blade, thus resulting in a total number of 30 240 vortex segments. The numerical integration for acoustic calculations must be carried out in time steps of at most 1° rotor rotation angle, that is to say 360 time steps per revolution, with at least five revolutions being required for a convergent solution. This results in 1800 time steps. The interaction of each of the 30 240 vortex segments on all of the vortex ends, the so-called nodes, must be determined in each of these times steps. This therefore results in a total of 1800 time steps×30 240 vortices×30 240 nodes, which corresponds to a total sum of 1.7×10¹¹ operations which must be carried out in order to make it possible to completely determine the geometry of the vortex system. This therefore requires a very large amount of computation power.

Because of this, there have already previously been efforts made to allow the vortex geometry to be calculated at least approximately, this being associated with a considerable reduction in the computation time. In this case, for the approximate calculation, certain operating conditions are predetermined as being constant, which in the end avoids the need to completely solve the equation of motion of the vortex system, and therefore reduces the computation time required by many orders of magnitude. The velocity of flight, the inclination of the rotor in space, the rotor thrust produced, the rotor rotation velocity and the blade twisting, for example, are in this case predetermined as being fixed, constant external operating conditions or operating parameters. One example of a so-called prescribed-wake method can be found, for example, in B. G. van der Wall. J. Yin: “Simulation of Active Rotor Control by Comprehensive Rotor Code with Prescribed Wake Using HART II Data”, 65th Annual Forum of the American Helicopter Society, Grapevine, May 27-29, 2009 or in B. G. van der Wall: “Der Einfluss aktiver Blattsteuerung auf die Wirbelbewegung im Nachlauf von Hubschrauberrotoren” [The influence of active blade control on the vortex movement in the wake of helicopter rotors], DLR-FB 1999-34 (1999). The major advantage of the prescribed-wake methods is that the vortex geometry can be calculated analytically on the assumption of a simple analytical description of the distribution of the induced velocity distribution on the rotor plane and behind it.

The disadvantage of the prescribed-wake method mentioned above and known from the prior art is the fact that this method is based on a steady-state lift distribution. During forward flight, the lift distribution on the rotor blade is, however, subject to considerable dynamic fluctuations during one revolution. Furthermore, a wide range of technical helicopter control systems have become known in the meantime, in which systems the individual rotor blades of a rotor change their lift several times during each revolution. By way of example, blade control systems such as these may be higher-harmonic control (HHC), individual blade control (IBC), local blade control with flaps (LBC) or connection control (active twist) and others. Control systems such as these are in this, case used successfully for noise reduction or for vibration reduction and can furthermore also reduce the drive power that is required. However, the abovementioned prescribed-wake method does not take account of dynamic lift changes in this form in each revolution.

The object of the present invention is therefore to specify a quick and effective method in which the vortex geometry change can be determined approximately and quickly, even with individual lift control.

According to the invention, this object is achieved by the method of the type mentioned initially, by the following steps:
Determination of a dynamic lift distribution on the rotor plane as a function of a lift change, which is correlated with n-times the rotor rotation frequency, on one of the rotor blades.
Determination of induced vertical velocities on the rotor plane as a function of the determined dynamic lift distribution on the rotor plane, and
Calculation of the vortex geometry change as a function of the induced vertical velocities.

It is therefore possible to take account of the dynamic components of the vortex geometry on the basis of a dynamic lift distribution such as this, with approximate calculation by means of a prescribed-wake method. For this purpose, a dynamic lift distribution on the rotor plane is defined as a function of a lift change which is correlated with a multiple of the rotor rotation frequency, on a rotor blade, for example in the form of a Fourier series. This allows the induced vertical velocities to be determined radially (polynomial approach) and azimuthally (Fourier series), for example, by means of an analytical function. This is because, for example, greater lift would, also result in these areas as a result, for example, of higher angles of attack at 0°, 90°, 180° and 270° which would correspond to four-times the rotor rotation frequency, and this would lead to a higher flow rate in these areas. The vortices would therefore descend more quickly in these areas.

According to the invention, the vertical velocities on the rotor plane that are induced by this dynamic lift distribution on the rotor plane are determined on this basis from this dynamic lift distribution. In this case, it has been found that, wherever greater lift is produced locally; an additionally induced velocity is also produced, directed downwards.

If these local lift changes are normalized with respect to the steady-state lift distribution, then, as a consequence, this means that, wherever the dynamic lift distribution is positive (locally greater lift), a velocity which is induced downward is created, while wherever the dynamic lift distribution is negative (locally reduced lift), an additionally induced velocity directed upward is produced. This means that the resultant vortices which are supported by the rotor plane with the velocity of flight experience, a corresponding vertical deflection because of these vertically induced velocities which result from the dynamic lift distribution, and this vertical deflection cannot be simulated by means of the steady-state lift distribution. The vortex geometry change, which cannot be determined using the conventional prescribed-wake methods, can now be calculated on the basis of these induced vertical velocities oh the rotor plane. Advantageously and additionally, the vertical vortex movement can now be derived using this vortex geometry change, thus allowing the actual vortex geometry to be calculated approximately.

Thus, even with the approximate calculation methods in which operating parameters of the rotor which are assumed to be constant are used as the calculation basis, dynamic lift distributions such as these can therefore be taken into account, which are of major importance for simulation of the rotor acoustics. This allows considerably more accurate simulations of the vortex geometry to be carried out, which would otherwise be possible only by using the free-wake methods.

Two-times to six-times the rotor rotation frequency is advantageously considered, which would correspond to one corresponding lift change per revolution. Based on the example mentioned above, this means that four-times the rotor rotation frequency is considered with respect to the lift change.

A radial distribution function f(r)=mr^{k} where k=0, 1, 2, . . . is advantageously used as the basis for determining the dynamic lift distribution and, in the simplest case, that is constant, that is to say f(r)=1 for k=0. However, it is also possible to take account of further radial distribution functions, which simulate a linear or square distribution. The behavior of the vortices can also be determined given velocities of flight by means of a progress degree, which is correlated with an assumed velocity of flight. This is because, as already mentioned above, the vortices which are produced in the forward area of the rotor plane are supported by the rotor plane because of the velocity of flight, and therefore have a considerable influence on the rotor acoustics.

Furthermore, the object is also achieved by a computer program which is designed to carry out the method and runs on a computer.

The invention will be explained in more detail with reference, by way of example, to the attached drawings, in which:

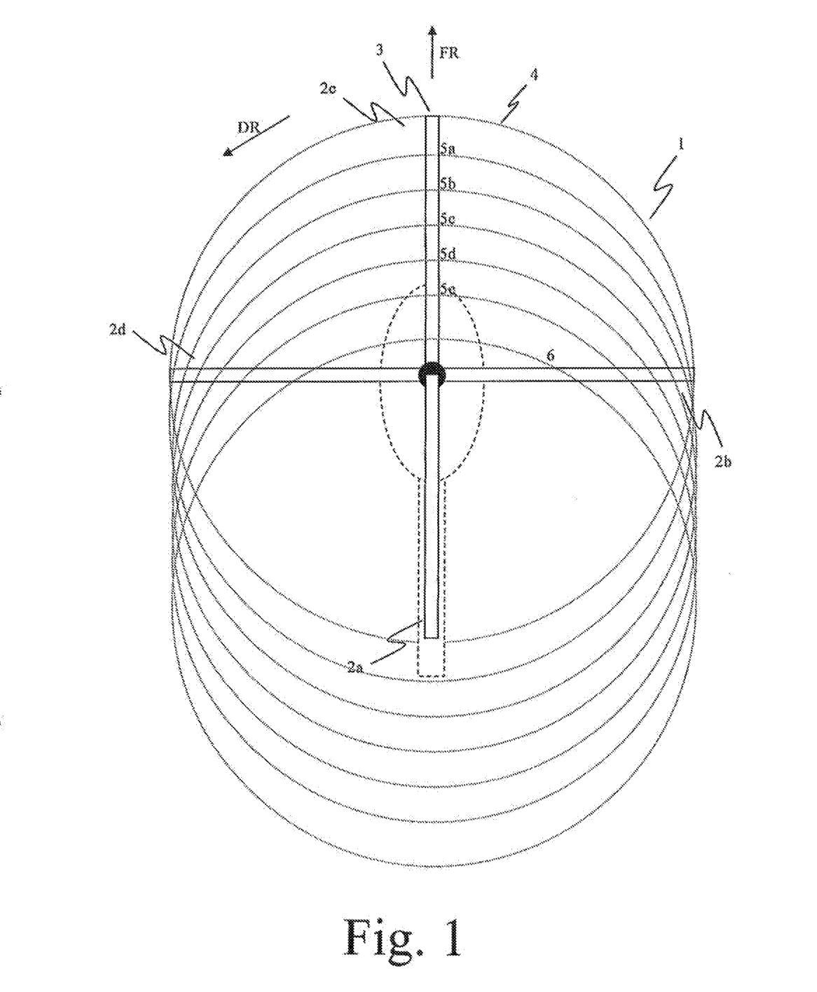

FIG. 1 shows a simplified schematic illustration of the vortex distribution in a plan view of a rotor;

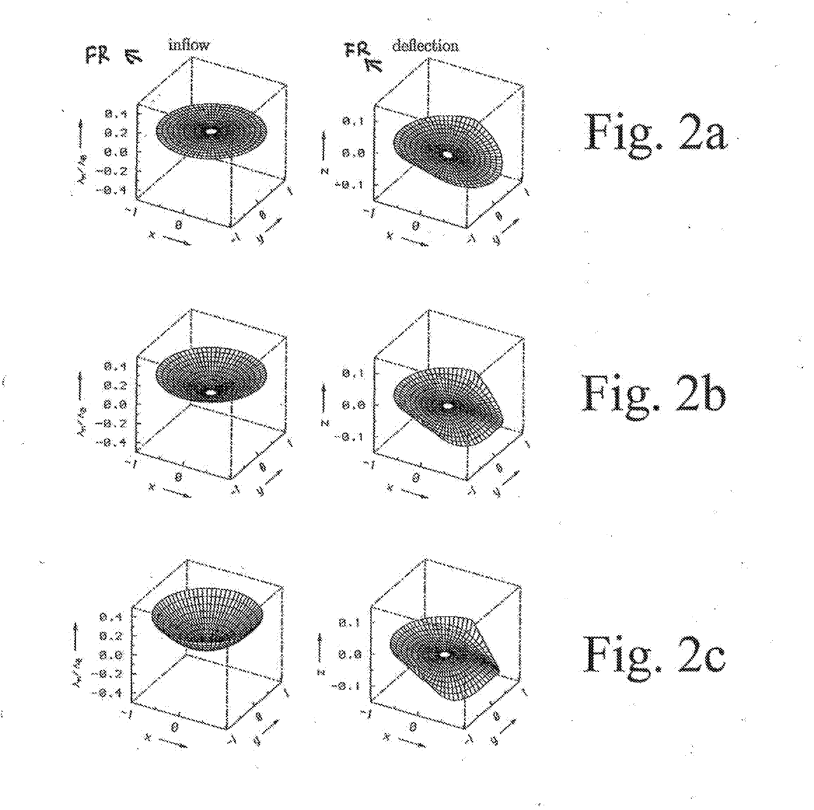

FIGS. 2a to 2c show an illustration of the through-flow and of the vortex deflection for a steady-state lift distribution with different radial distribution functions as are used in the prescribed-wake methods known from the prior art;

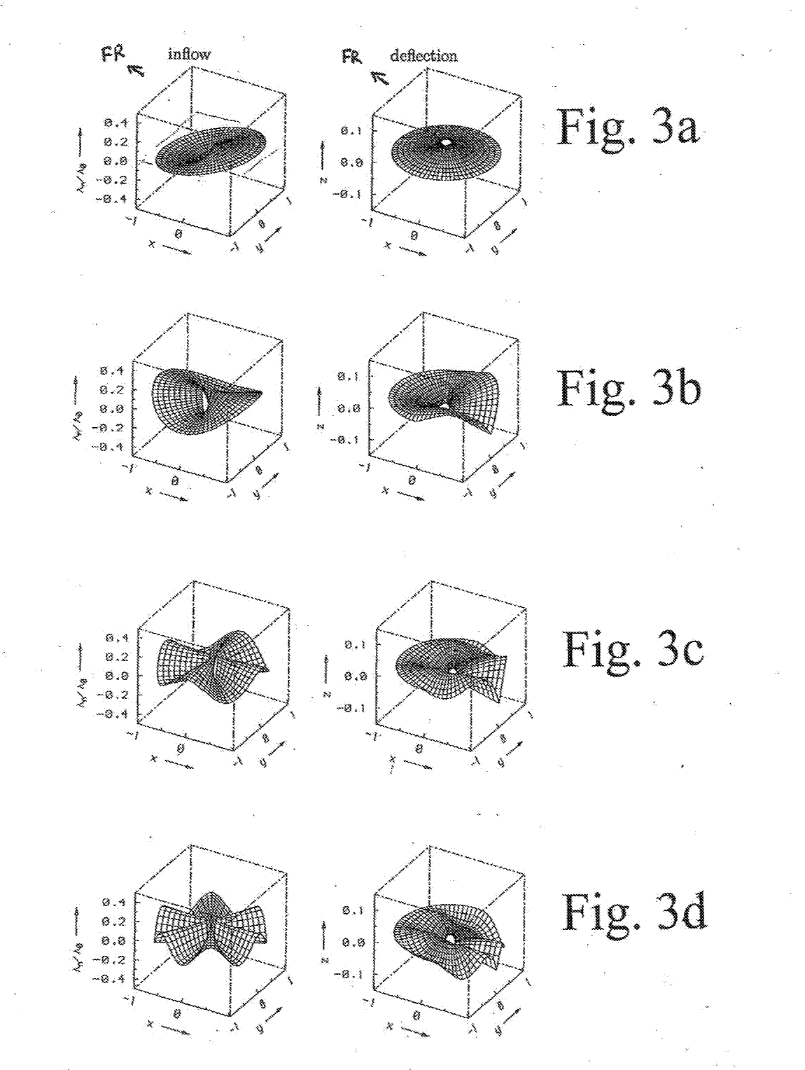

FIGS. 3a to 3d show an illustration of the through-flow and of the vertical vortex deflection for a dynamic lift distribution with a constant radial distribution function (f(r)=1, n=1, 2, 4, 6);

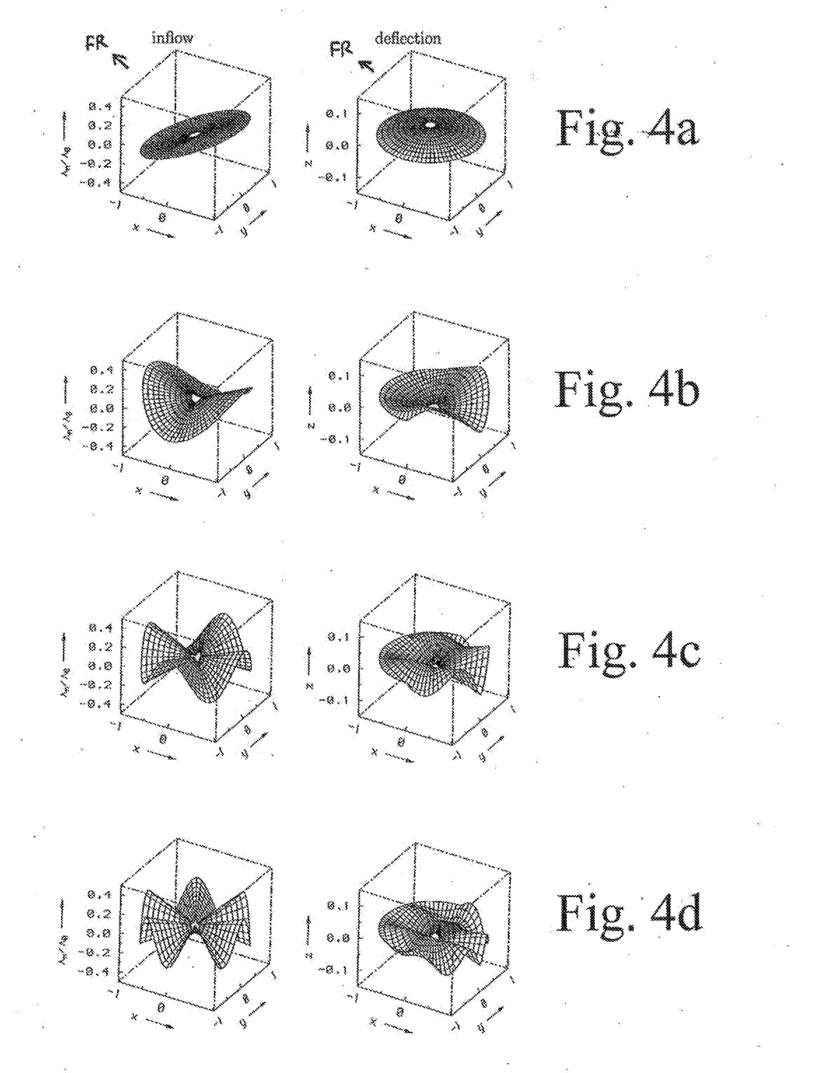

FIGS. 4a to 4d show an illustration of the through-flow and of the vertical vortex deflection for a dynamic lift distribution with a linear radial distribution function (f(r)=r, n=1, 2, 4, 6);

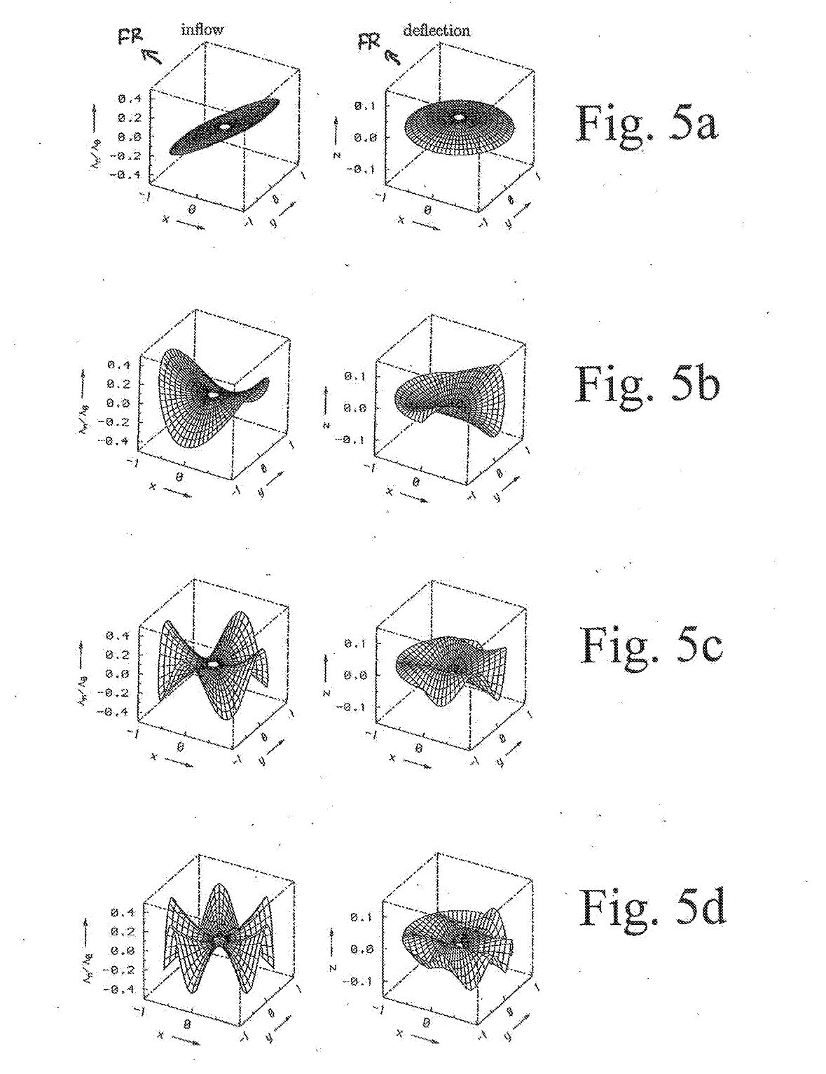

FIGS. 5a to 5d show an illustration of the through-flow and of the vertical vortex deflection for a dynamic lift distribution with a square radial distribution function (f(r)=r², n=1, 2, 4, 6).

FIG. 1 shows ah illustration of a vortex distribution of a helicopter rotor 1 which comprises four rotor blades 2a to 2d. The rotor is rotating in a rotation direction DR, which is indicated by an appropriate arrow. The rotor 1 has four rotor blades 2a to 2d which, in the exemplary embodiment illustrated in. FIG. 1, are aligned in a specific manner. The alignment of the rotor blade 2a is denoted fundamentally to be 0°, while the rotor blade 2c pointing in the direction or flight is at a rotation angle of 180°. The rotor blade 2b at 90° and the rotor blade 2d at 270° are in this case directly at right angles to the direction of flight. Vortices 4 are produced at the rotor blade tips 3 during revolution, and migrate through the rotor plane over time because of the velocity of the flight in the direction of flight FR. This is represented by the vortices 5a to 5e, which indicate different positions over time. When one rotor blade, for example, the rotor blade 2b, now strikes a vortex such as this which is located oh the rotor plane, for example the vortex 6, then this has an enormous influence on the noise developed by the rotor 1, in which case it can be confirmed that the noise development becomes greater the closer the rotor blade 2b passes by the vortex.

Let us how refer to FIGS. 2a to 2c, which show an illustration of the vertical through-flow and of the vertical vortex deflection caused by this in a steady-state lift distribution. In this case, FIG. 2a shows the case in which a constant radial distribution function f(r)=1 is used while FIG. 2b shows the case in which a linear radial distribution function f(r)=r was used. Finally, FIG. 2c shows the case in which a square radial distribution function f(r)=r² was used.

The diagram on the left-hand side of FIG. 2a shows the normalized induced through-flow degree based on a constant radial distribution function. The illustrated example relates to a constant thrust, that is to say the lift does not change because of dynamic components during rotor rotation.

If a linear radial distribution function is now used, as can be seen in FIG. 2b, then the diagram on the left-hand side shows that the through-flow increases linearly as the distance from the center point of the rotor plane increases. Conversely, this means that the closer one is to the center point of the rotor plane, the less the through-flow is as well.

Finally, FIG. 2c then shows the use of a square radial distribution function, in which the lift and therefore the through-flow increase on a square-law basis as the distance from the rotor center point increases.

The right-hand sides of FIGS. 2a to 2c then show the deflection of the vortices on the rotor plane which results from the induced through-flow and therefore from the lift. As can be seen, there are scarcely any downward deflections in this case in the vertical direction, in particular on the edge areas of 90° and 270°, since the vortex remains in the through-flow field for only a short time.

The implementation of the present method according to the invention will now be described with reference to an example. The associated vertical vortex position change is calculated on the basis of a lift distribution which varies at n-times the rotor rotation frequency on the rotor blade. N is the number of rotor blades, U=Ω*R is the circumferential velocity of the blade tips, A=Π*R² is the rotor circular area and Lₙ is the dynamic component of the blade lift, which is correlated with n-times the rotor rotation frequency, ρ is the air density and V is the velocity of flight. According to the ray theory, which is known from helicopter aerodynamics, the induced through-flow degree λᵢₙₕ for the respective n-times the rotor rotation frequency (first of all ignoring the velocity of flight) is:

$${λ}_{inh} = \sqrt{\frac{{NL}_{n}}{2 ρ {AU}^{2}}} \\ n = 2 , 3 , … , 6 ; \\ {λ}_{ih} = \sqrt{\frac{T}{2 ρ {AU}^{2}}} \qquad ( 1 )$$

where T=NL₀.

A velocity of flight must be considered next as a basis, which is included in the formula with the aid of the progress degree μ=V/U. For the sake of simplicity, the angle of incidence of the rotor plane for the velocity of flight was set to zero, since this allows an analytical solution. In the general case, this ratio must be solved iteratively:

$$\frac{{λ}_{in}}{{λ}_{inh}} = \frac{{λ}_{i}}{{λ}_{ih}} = \sqrt{\sqrt{\frac{1}{4} {( \frac{μ}{{λ}_{ih}} )}^{4} + 1} - \frac{1}{2} {( \frac{μ}{{λ}_{ih}} )}^{2}} = g ( μ , {λ}_{ih} ) \\ n = 2 , 3 , … , 6 \qquad ( 2 )$$

This dynamic lift distribution at each of the n-times the rotor rotation frequency has a phase angle ψₙ on the rotor plane, where ψ is the revolution angle of the rotor blade, where ψ=0 when the blade is pointing aft. The dynamic lift and the associated dynamically induced velocity distribution are then represented as follows:

Lₙ(ψ)=L_{nS} sin nψ+L_{nC} cos nψ=Lₙ cos(nψ−ψn) n=2,3, . . . ,6 (3)

λᵢₙ(ψ)=(λ_{inS} sin nψ+λ_{inC} cos nψ)f(r)=λᵢₙf(r)cos(nψ−ψₙ) (4)

where

λ_{inS}=λᵢₙₕg(μ,λᵢₕ)sin ψₙ and λ_{inC}=λᵢₙₕg(μ,λᵢₕ)cos ψₙ (5)

where the phase is given by ψₙ=arctan (L_{nS}/L_{nC}) and f(r) represents a radial distribution function. The simplest distribution for the radial distribution function is the constant distribution, for which f(r)=1. However, linear or square distributions can also be used (f(r)=fₘr^{m} where m=1, 2). The constant fₘ must be chosen such that the magnitude of the total impulse for each m remains the same.

A transformation is now required from polar coordinates to the Cartesian system, because the vortex trajectory must be calculated using the Cartesian system. Since the fundamental principle for all higher-frequency components is the same, that is the complexity of the expressions increases as n and m rise, only the example m=2 will be demonstrated in the following text, which corresponds to twice the rotor rotation frequency. In other words, during one rotor blade revolution, the lift changes twice, and only twice, during this revolution. With the radius of a point within the rotor plane being r=\sqrt{x²+y²} and using the conversion formulae:

$$\begin{matrix}x = r cos ψ ⇒ {cos}^{2} ψ = \frac{{x}^{2}}{{x}^{2} + {y}^{2}} & ( 6 ) \\ y = r sin ψ ⇒ {sin}^{2} ψ = \frac{{y}^{2}}{{x}^{2} + {y}^{2}} & ( 7 ) \\ cos 2 ψ = {cos}^{2} ψ - {sin}^{2} ψ = \frac{{x}^{2} - {y}^{2}}{{x}^{2} + {y}^{2}} & ( 8 ) \\ sin 2 ψ = 2 sin ψcosψ = 2 \frac{xy}{{x}^{2} + {y}^{2}} & ( 9 )\end{matrix}$$

It then follows using f(r)=fₙrⁿ=fₙ(x²+y²)^{n/2}=f(x,y)

$${λ}_{i 2} = 2 {λ}_{i 2 S} \frac{xy}{{x}^{2} + {y}^{2}} f ( x , y ) + {λ}_{i 2 C} ( \frac{{x}^{2}}{{x}^{2} + {y}^{2}} - \frac{{y}^{2}}{{x}^{2} + {y}^{2}} ) f ( x , y ) \qquad ( 10 )$$

All the coordinates in these equations have been made dimensionless by division by the rotor radius R. In order to determine the position of a vortex point along a line y=konst. From its point of origin at xₐ=cos ψ_{b}, it is necessary to integrate over the time which is required to a point x. In this case, ψ_{b} is the rotation angle of the rotor blade at which the vortex point under consideration is released into the flow field, with the radial point of origin being assumed to occur at the blade tip at r=1, for the sake of simplicity. In a dimensionless form, the time t=xR/V results in Ωt=x(ΩR)/V=x/μ, from which, also, dt=dx/Ωμ). The integral over time then leads to the vertical vortex deflections:

$$z ( x , y ) = \frac{1}{R} {\int }_{{t}_{a}}^{t} {v}_{i} ( x , y , t ) d t = μ {\sum }_{n = 2}^{6} {\int }_{{x}_{a}}^{x} {λ}_{in} ( x , y ) f ( x , y ) d x \qquad ( 11 )$$

For the sake of simplicity the following text will consider only that component which varies at twice the rotor rotation frequency (m=2). Furthermore, the radial distribution function is set to the lowest order, that is to say m=0 and fₘ=1, which likewise simplifies the resultant formula. If the expression for the induced through-flow degree is introduced, it follows that:

$$z ( x , y ) = 2 y \frac{{λ}_{i 2 S}}{μ} {\int }_{{x}_{a}}^{x} \frac{x}{{x}^{2} + {y}^{2}} d x + \frac{{λ}_{i 2 C}}{μ} {\int }_{{x}_{a}}^{x} \frac{{x}^{2}}{{x}^{2} + {y}^{2}} d x - {y}^{2} \frac{{λ}_{i 2 C}}{μ} {\int }_{{x}_{a}}^{x} \frac{1}{{x}^{2} + {y}^{2}} d x \qquad ( 12 )$$

The integral can then be solved analytically:

$$\int \frac{{x}^{n}}{{y}^{2} + {x}^{2}} d x = \{ \begin{matrix}\frac{1}{y} arctan \frac{x}{y} & n = 0 \\ \frac{1}{2} ln ( {y}^{2} + {x}^{2} ) & n = 1 \\ x - arctan \frac{x}{y} & n = 2\end{matrix} \qquad ( 13 )$$

The higher the frequency n and the higher the order of the radial distribution function m, the more complex and extensive the expressions become. For the simplest case under consideration here, for which n=2 and m=0 this results in:

$$z ( x , y ) = {[ y \frac{{λ}_{i 2 S}}{μ} ln ( {x}^{2} + {y}^{2} ) + \frac{{λ}_{i 2 C}}{μ} ( x - 2 y arctan \frac{x}{y} ) ]}_{{x}_{a}}^{x} \qquad ( 14 )$$

The initial point xₐ=cos ψ_{b} is of interest only for the range 90°<ψ_{b}<270°, since only the blade tip vortices produced in this range pass through the rotor plane and therefore the higher-frequency induced velocity fields located therein. The vortices which are produced in the rest of the range are supported immediately behind the rotor plane and no longer have any influence, on the plane.

The blade tip vortices are created in the vicinity of the rotor blade tips and are carried away aft at the velocity of flight. In this case, all vortices which are created on the front face of the rotor have to pass through the rotor plane and therefore have to pass through not only the induced velocity field which is produced by the steady-state thrust but also through the field which was produced by the dynamic lift distribution, as described above. These induced velocities produce vertical movements of the original vortex position.

This therefore allows the total resultant vortex geometry to be composed of the two components.

FIGS. 3a to 3d show the representation of the through-flow and of the vertical vortex deflection for a dynamic lift distribution with a constant radial distribution function f(r)=1. In this context FIG. 3a shows the case in which the dynamic lift distribution is correlated with the simple rotor rotation frequency (n=1), that is to say, as is illustrated in the left-hand example, dynamic lift is produced once and only once in each revolution of a rotor blade. The right-hand side then in each case shows the corresponding deflection which results from this dynamic lift distribution.

The dynamic lift distribution at twice the rotor rotation frequency (n=2) is in this case shown by way of example in FIG. 3b, in which a lift change in the rotor revolution is produced both at an angle of 0° and at an angle of 180°. Because the rotor is moving forward, the greatest deflection can be seen in the aft area (phase 0°), and this is represented by a discrepancy inclined clearly downward in the induced vertical velocities in the right-hand figure.

For illustration, reference should also be made to FIG. 3c, in which the dynamic lift distribution is correlated with four-times the rotor rotation frequency (n=4), and FIG. 3d, in which the dynamic lift distribution is correlated with six-times the rotor rotation frequency (n=6). In this case, the right-hand figure in each case shows the vertical discrepancy which results from the dynamic lift distribution.

Analogously to this reference is made to FIGS. 4a to 4d and 5a to 5d, which each show a dynamic lift distribution at n-times the rotor rotation frequency, with FIGS. 4a to 4d being based oh a linear radial distribution function (m=1), while a square radial distribution function (m=2) was used in FIGS. 5a to 5d. In this case, FIGS. 5a to 5d in particular show that the square radial distribution function used results in the through-flows being locally considerably greater, and increasing on a square-law basis as the distance from the center of the rotor plane increases.

This then also leads to an increase in the induced velocities and therefore to ah increased vertical deflection. The increase in the amplitude on the edge is a consequence of maintaining the total impulse by the factor fₘ.

The dynamic content of the lift distribution is determined with the aid of Fourier analysis, thus resulting in the components which are correlated with n-times the rotor rotation frequency, to be precise in magnitude (=amplitude) and phase (relative to ψ=0°).

This present method, according to the invention therefore allows the additional vortex position changes produced by the dynamic lift distribution to be calculated approximately, and therefore to be used for the so-called prescribed-wake method. The method is iterative and can be used in parallel with known rotor simulations.

1. A method for determining a vortex geometry change of rotor vortices which are formed on a rotor which comprises a plurality of rotor blades, having the following steps:
Determination of a dynamic lift distribution on the rotor plane as a function of a lift change, which is correlated with n-times the rotor rotation frequency, on the rotor blades.
Determination of induced vertical velocities on the rotor plane as a function of the determined dynamic lift distribution on the rotor plane, and
Calculation of the vortex geometry change as a function of the induced vertical velocities.

2. The method as claimed in claim 1, comprising calculation of the vortex geometry change in the form of vertical movements of the rotor vortices.

3. The method as claimed in claim 1, comprising a lift change which is correlated with two-times to six-times the rotor rotation frequency.

4. The method as claimed in claim 1, comprising determination of the dynamic lift distribution as a function of a radial distribution function, in particular of a constant, linear or square distribution function.

5. The method as claimed in claim 1, comprising determination of the dynamic lift distribution furthermore as a function of a progress degree which is correlated with a velocity of flight.

6. The method for determining a vortex geometry on a rotor which comprises a plurality of rotor blades, in which a steady-state lift, distribution of the rotating rotor is first of all calculated approximately as a function of rotor operating parameters which are assumed to be constant, wherein the vortex geometry is determined as a function of the steady-state lift distribution and the vortex geometry change of the rotor vortices as claimed in claim 1.

7. A computer program having program code means designed to carry out the method as claimed in claim 1 when the computer program is run on a computer.

8. A computer program having program code means, which are stored on a machine-legible carrier, designed to carry out the method as claimed in claim 1 when the computer program is run on a computer.
